(19) United States
(12) Patent Application Publication
(10) Pub. No.: US 2004/0079736 A1
(43) Pub. Date: Apr. 29, 2004

(54) Plasma arc torch continuity device and methods of use therefor

(76) Inventors: Jonathan Brasseur, Cornish, NH (US); Kevin D. Horner-Richardson, Cornish, NH (US)

Correspondence Address: Kelly K. Burris, Esq., Harness, Dickey & Pierce, P.L.C., Suite 400, 7700 Bonhomme Avenue, Saint Louis, MO, 63105, US

(21) Appl. No.: 10/280,888

(22) Filed: Oct. 24, 2002

(51) Int. Cl. B23K 10/00

(52) U.S. Cl. 219/121.52

(57) ABSTRACT

A continuity device for use in a torch height control system of a plasma arc torch is provided that comprises a reattachable engagement member, a connection member, and a contact member in electrical continuity with the connection member and disposed distally from the reattachable engagement member. Accordingly, when the reattachable engagement member is secured to a proximal component of the plasma arc torch, the contact member is in electrical contact with a distal component of the plasma arc torch, thereby providing electrical continuity to the torch height control system through the connection member. Advantageously, the continuity device is reattachable and thus provides for ease of use and replacement of components, such as consumables, of the plasma arc torch. Additionally, methods of using the reattachable continuity device are provided, wherein a distal component of the plasma arc torch contacts a workpiece and electrical continuity is provided through the reattachable continuity device.

### FIELD OF THE INVENTION

The present invention relates generally to plasma arc torches and more particularly to devices and methods for operating a torch height control system.

### BACKGROUND OF THE INVENTION

Plasma arc torches, also known as electric arc torches, are commonly used for cutting, marking, gouging, and welding metal workpieces by directing a high energy plasma stream consisting of ionized gas particles toward the workpiece. In a typical plasma arc torch, the gas to be ionized is supplied to a distal end of the torch and flows past an electrode before exiting through an orifice in the tip, or nozzle, of the plasma arc torch. The electrode has a relatively negative potential and operates as a cathode. Conversely, the torch tip constitutes a relatively positive potential and operates as an anode. Further, the electrode is in a spaced relationship with the tip, thereby creating a gap, at the distal end of the torch. In operation, a pilot arc is created in the gap between the electrode and the tip, which heats and subsequently ionizes the gas. Further, the ionized gas is blown out of the torch and appears as a plasma stream that extends distally off the tip. As the distal end of the torch is moved to a position close to the workpiece, the arc jumps or transfers from the torch tip to the workpiece because the impedance of the workpiece to ground is lower than the impedance of the torch tip to ground. Accordingly, the workpiece serves as the anode, and the plasma arc torch is operated in a “transferred arc” mode.

In mechanized, or automated plasma arc torch applications, a torch height control system is typically employed to establish and maintain a proper distance between the plasma arc torch and a workpiece during cutting operations, which is commonly referred to as a standoff height. Typically, a height-find circuit is employed, wherein the location of the plasma arc torch is first zeroed-out by physically contacting the plasma arc torch or a component thereof with the workpiece. Once electrical continuity is sensed, a reference position is established and the plasma arc torch is retracted to an initial set height. During the cutting process, the height of the plasma arc torch from the workpiece is controlled by monitoring the voltage through the plasma arc torch and comparing the voltage to a reference voltage set by an operator and subsequently making height adjustments based on the difference between the monitored voltage and the reference voltage.

Known methods of establishing the reference position by way of contacting the plasma arc torch with workpiece include positioning a microswitch on the plasma arc torch. When the plasma arc torch is lowered, movement of a drive mechanism relative to other torch components activates the microswitch, which subsequently sends an electrical signal to the torch height control system. Unfortunately, with thinner workpieces such as sheet metal, the workpiece often deforms under the pressure required to displace the arm of the microswitch for electrical contact. As a result, the torch height control system is inaccurate because the height of the plasma arc torch from the workpiece does not account for the initial deformation of the workpiece.

In another method of establishing the reference voltage by way of contacting the workpiece, a wire is attached to a distal torch component such as a metallic or conductive shield cup. In one known form, the wire is attached to the shield cup by soldering a tab onto the shield cup and also soldering the wire to the tab. The wire is then used to physically contact the workpiece and to provide electrical continuity to the torch height control system. In another known form, a band with a tab is crimped onto the shield cup and the wire is similarly soldered to the tab. However, the shield cup is often removed to replace consumable components within the torch such as an electrode or a tip, and the shield cup itself is also replaced periodically as a consumable component. As a result, attachment and reattachment of the torch height control system to the plasma arc torch is time consuming and tedious with the soldering and crimping attachment methods of the known art. Further, since the band and the tab are not easily removable from the shield cup, additional time is required for removal and reattachment thereof, which often results in disposal of the shield cup. Therefore, attachment and reattachment of the shield cup or other consumable component is also time consuming and tedious in known art systems.

### SUMMARY OF THE INVENTION

In one preferred form, the present invention provides a continuity device for use in a torch height control system of a plasma arc torch. The continuity device comprises a reattachable engagement member, a connection member, and a contact member in electrical continuity with the connection member and disposed distally from the reattachable engagement member. When the reattachable engagement member is secured to a proximal component of the plasma arc torch such as a torch head, the contact member is in electrical contact with a distal component of the plasma arc torch such as a shield cap, thereby providing electrical continuity to the torch height control system through the connection member. Advantageously, the continuity device is reattachable and thus may be readily installed and removed from the plasma arc torch as needed without requiring the removal or disposal of other torch components, including by way of example, consumables such as a shield cap or cup. Moreover, the consumables are easily removed from the plasma arc torch without removing the continuity device.

Preferably, the reattachable engagement member defines a resilient clamping ring adapted for engagement around the proximal component. Further, the resilient clamping ring preferably defines radially opposed tabs that engage slots in the proximal component to further secure the resilient clamping ring to the proximal component. Additionally, the resilient clamping ring further defines resilient fingers that extend radially outward to facilitate installation and removal of the continuity device.

In another form, a plasma arc torch is provided that is adapted for operation with a torch height control system. The plasma arc torch comprises a proximal torch component such as a torch head, a distal torch component such as a shield cap or shield cup disposed distally from the proximal torch component, and a reattachable continuity device secured to the proximal torch component and in electrical contact with the distal torch component. Furthermore, the reattachable continuity device is adapted for electrical connection to the torch height control system. Therefore, the reattachable continuity device provides an electrical path from a workpiece to the torch height control system.

In yet another form, a method of operating a plasma arc torch height control system is provided that comprises the steps of lowering a plasma arc torch such that a distal component of the plasma arc torch is in contact with a workpiece, and sensing electrical continuity through a reattachable continuity device secured to the plasma arc torch and in electrical contact with the distal component.

In still another form, a method of operating a plasma arc torch height control system is provided that comprises the step of sensing electrical continuity through a reattachable continuity device secured to the plasma arc torch and in electrical contact with a distal component of the plasma arc torch when the distal component contacts a workpiece. Further, another form of the present invention provides a method of operating a plasma arc torch height control system that comprises the step of securing a reattachable continuity device to a plasma arc torch for electrical continuity between a workpiece and the torch height control system. Additionally, a further method comprises the step of attaching a component of the torch height control system to a reattachable continuity device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is front view of a continuity device secured to a plasma arc torch and constructed in accordance with the principles of the present invention;

FIG. 2 is an enlarged front view, taken from detail A of FIG. 1, of the continuity device secured to a plasma arc torch in accordance with the principles of the present invention;

FIG. 3 is a perspective view of the continuity device constructed in accordance with the principles of the present invention;

FIG. 4 is a side view of the continuity device in accordance with the principles of the present invention;

FIG. 5 is a top view of the continuity device in accordance with the principles of the present invention;

FIG. 6 is a front view of the continuity device in accordance with the principles of the present invention;

FIG. 7 is a cross-sectional view, taken along line B-B of FIG. 1, of the continuity device secured to the plasma arc torch according to the principles of the present invention; and

FIG. 8 is an enlarged view, taken from detail C of FIG. 7, illustrating retaining members of the continuity device engaged within slots formed in a proximal component of the plasma arc torch in accordance with the principles of the present invention.

### DETAILED DESCRIPTION OF THE PREFERRED EMBODIMENTS

The following description of the preferred embodiments is merely exemplary in nature and is in no way intended to limit the invention, its application, or uses.

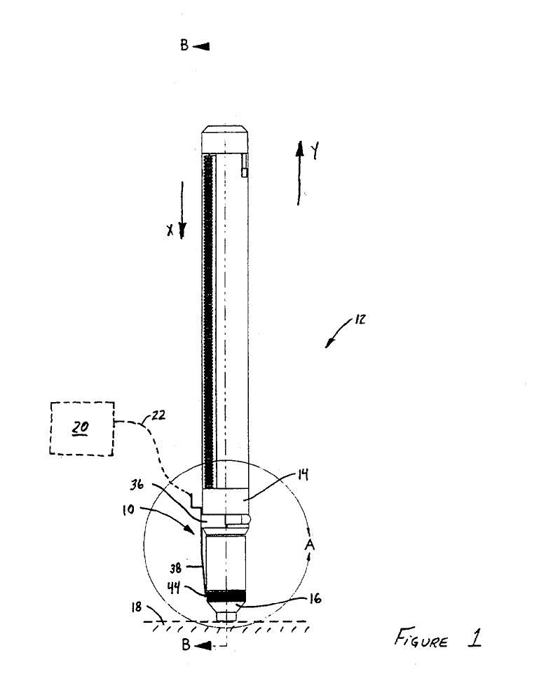

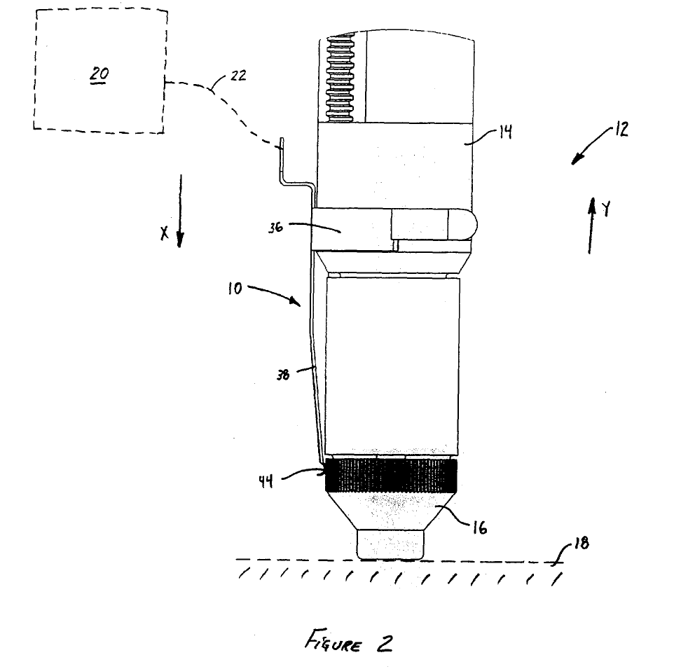

Referring to the drawings, a continuity device according to the present invention is illustrated and generally indicated by reference numeral 10 in FIGS. 1 and 2. The continuity device 10 is shown secured to a first component of a plasma arc torch 12, and more specifically to a proximal component 14, which in the preferred embodiment of the present invention is commonly referred to as a torch head. Further, the continuity device 10 is in electrical contact with a second component of the plasma arc torch 12, and more specifically to a distal component 16, which in the preferred embodiment of the present invention is commonly referred to as a shield cap. Moreover, the proximal component 14 is preferably fixed and the distal component 16 is preferably removable, i.e. a consumable component, in one form of the present invention. However, the first and second torch components may be either fixed or removable while remaining within the scope of the present invention. Accordingly, when the distal component 16 is in contact with a workpiece 18, electrical continuity is provided through the continuity device 10 to a torch height control system 20, through, for example, a hard-wire lead 22. Such contact is initiated to establish a proper standoff height of the plasma arc torch 12 through the torch height control system 20, the operation of which is known in the art and shall not be described herein for purposes of clarity.

As used herein, a plasma arc torch, whether operated manually or automated, should be construed by those skilled in the art to be an apparatus that generates or uses plasma for cutting, welding, spraying, gouging, or marking operations, among others. Accordingly, the specific reference to plasma arc cutting torches, plasma arc torches, or automated plasma arc torches herein should not be construed as limiting the scope of the present invention. Additionally, the terms “distal” or “distally” shall be construed as meaning towards or in the direction of arrow X, and the terms “proximal” or “proximally” shall be construed as meaning towards or in the direction of arrow Y.

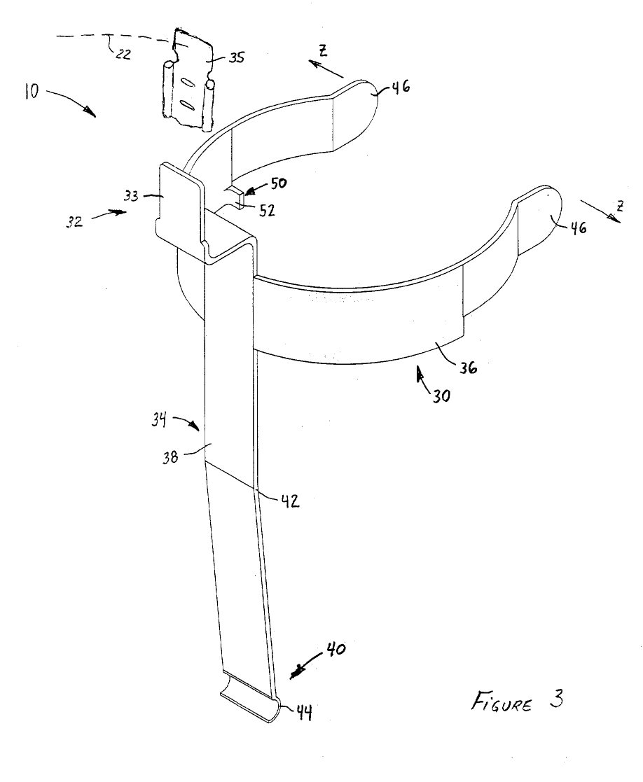

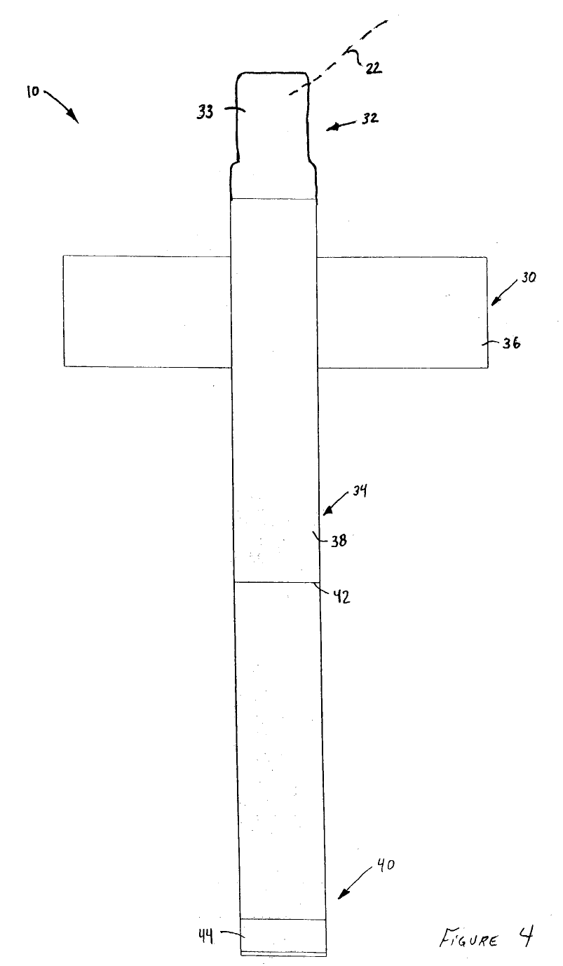

Referring now to FIGS. 3 through 6, the continuity device 10 according to the present invention further comprises a reattachable engagement member 30, a connection member 32, and a contact member 34. As shown, the connection member 32 is preferably a tab 33 disposed proximate the reattachable engagement member 30 and extends radially therefrom. Further, the hard-wire lead 22 is secured to the tab 33 using, by way of example, a quick connect/disconnect receptacle such as a FASTON® receptacle 35 provided by AMP, Inc.

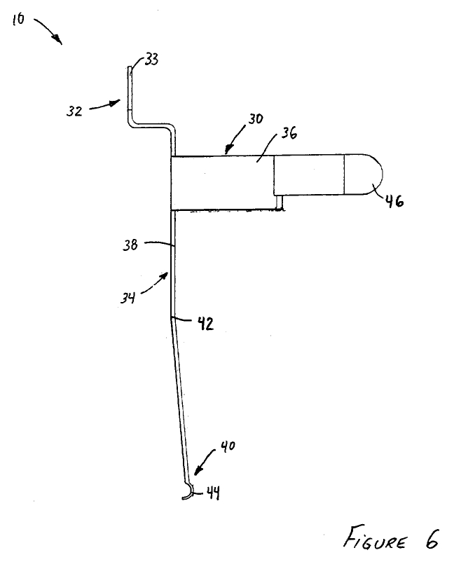

Preferably, the contact member 34 defines a resilient arm 38 extending distally from the reattachable engagement member 30. As shown, the resilient arm 38 is biased inward towards a distal end 40 thereof through a bend 42, which is best shown in FIG. 6. Accordingly, the resilient arm 38 is biased against the distal component 16 (not shown) when the continuity device 10 is secured to the plasma arc torch 12 (not shown), which is shown and described in greater detail below. Further, the resilient arm 38 defines a bead 44 that extends radially inward to contact the distal component 16. Preferably, the bead 44 defines an arcuate configuration as shown, wherein contact of the bead 44 with the distal component 16 is a line or point contact rather that a surface contact. However, other configurations for the bead 44 that define point, line, or surface contact with the distal component 16 may also be employed while remaining within the scope of the present invention.

As further shown, the reattachable engagement member 30 preferably defines a resilient clamping ring 36 adapted for engagement around the proximal component 14 (not shown), which is shown described in greater detail below. The resilient clamping ring 36 further defines resilient fingers 46 that extend outward as shown. Accordingly, the resilient fingers 46 facilitate installation and removal of the continuity device 10, wherein an operator flexes the resilient fingers 46 radially outward in the direction of arrows Z. As a result, the resilient clamping ring 36 is also displaced radially outward and thus disengages from the proximal component 14, thereby facilitating ease of removal of the continuity device 10. Similarly, the resilient fingers 46 may be flexed radially outward for ease of installation of the continuity device 10 onto the proximal component 14.

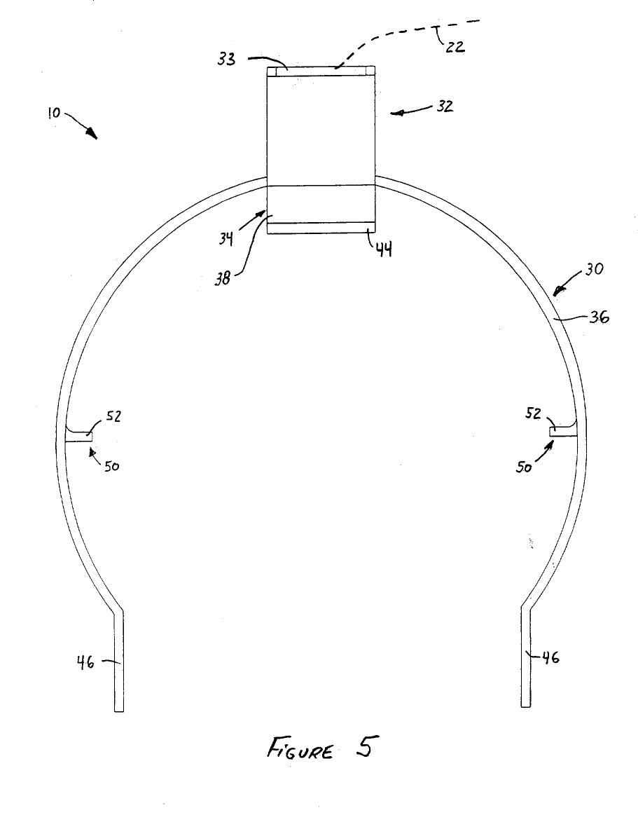

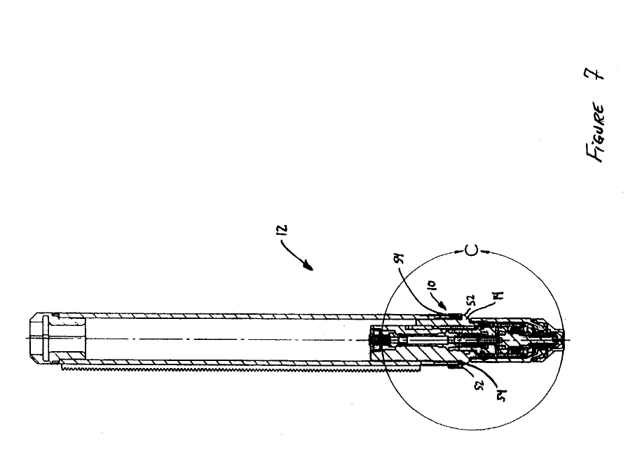

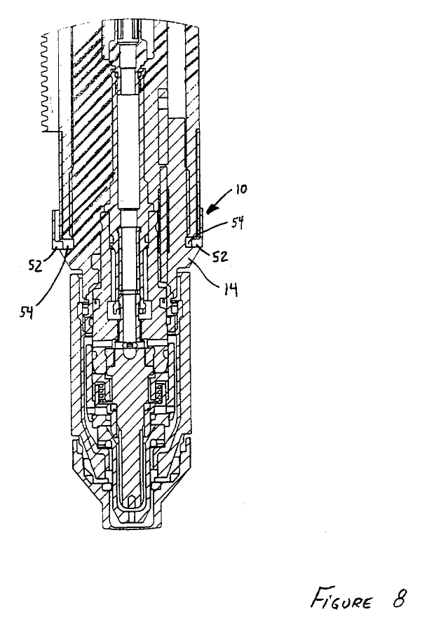

Additionally, as best shown in FIGS. 3 and 5, the resilient clamping ring 36 further defines a retaining member 50. In the preferred form, the retaining member 50 comprises radially opposed tabs 52, which secure the continuity device 10 the proximal component as best shown in FIGS. 7 and 8. As shown, the radially opposed tabs 52 engage slots 54 formed in the proximal component 14, wherein the slots 54 are sized to accommodate the radially opposed tabs 52 therein. As a result, the continuity device 10 is further secured to the proximal component 14 such that rotation or displacement of the continuity device 10 is limited by the radially opposed tabs 52.

Preferably, the continuity device 10 is a spring-tempered stainless steel material. However, other conductive, resilient materials may also be employed while remaining within the scope of the present invention. Further, the continuity device 10 as shown is preferably a single piece, however, separate pieces may be assembled together to form a continuity device 10 in accordance with the present teachings while remaining within the scope of the present invention.

In operation, with reference back to FIGS. 1 and 2, the continuity device 10 is installed on a plasma arc torch 12 with the resilient clamping ring 36 engaging the proximal component 14 and the bead 44 of the resilient arm 38 contacting the distal component 16. Accordingly, when the continuity device 10 is attached to the plasma arc torch 12 and the distal component 16 is lowered to contact the workpiece, electrical continuity is provided through the continuity device 10. More specifically, electrical continuity is provided from the workpiece 18, through the distal component 16, through the bead 44, through the resilient arm 38, through the tab 33, through the receptacle 35, through the hard-wire lead 22, and to the torch height control system 20. Accordingly, when the plasma arc torch 12 is lowered to contact the workpiece 18, the continuity device 10 provides for electrical continuity to the torch height control system 20, and the plasma arc torch 12 may be subsequently raised to a proper standoff height as determined by the torch height control system 20.

Accordingly, a continuity device 10 is provided by the present invention that is reattachable and thus relatively simple to install and remove from a plasma arc torch 12. As a result, operation of a torch height control system 20 is more efficient with the ability to readily install and remove the continuity device 10 as required, further without the unnecessary modification or disposal of other torch components such as a consumable shield cup or cap.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A continuity device for use in a torch height control system of a plasma arc torch comprising:
a reattachable engagement member;
a connection member; and
a contact member in electrical continuity with the connection member and disposed distally from the reattachable engagement member,
wherein when the reattachable engagement member is secured to a first component of the plasma arc torch, the contact member is in electrical contact with a second component of the plasma arc torch, thereby providing electrical continuity to the torch height control system through the connection member.

2. The continuity device according to claim 1, wherein the continuity device is a single piece.

3. The continuity device according to claim 1, wherein the reattachable engagement member defines a resilient clamping ring adapted for engagement around the first component.

4. The continuity device according to claim 3, wherein the resilient clamping ring defines a retaining member that further secures the continuity device to the first component.

5. The continuity device according to claim 4, wherein the retaining member defines radially opposed tabs that engage the first component.

6. The continuity device according to claim 3, wherein the resilient clamping ring further defines at least one resilient finger extending radially outward to facilitate installation and removal of the continuity device.

7. The continuity device according to claim 3, wherein the resilient clamping ring further defines two resilient fingers extending radially outward to facilitate removal of the continuity device.

8. The continuity device according to claim 1, wherein the connection member extends radially from the reattachable engagement member.

9. The continuity device according to claim 1, wherein the contact member defines a resilient arm extending distally from the reattachable engagement member.

10. The continuity device according to claim 9, wherein the resilient arm further defines a bead that extends radially inward to contact the second component.

11. A plasma arc torch adapted for operation with a torch height control system comprising:
a proximal torch component;
a distal torch component disposed distally from the proximal torch component; and
a reattachable continuity device secured to the proximal torch component and in electrical contact with the distal torch component,
wherein the continuity device is adapted for electrical connection to the torch height control system.

12. The plasma arc torch according to claim 11, wherein the continuity device comprises:
a reattachable engagement member;
a connection member; and
a contact member in electrical continuity with the connection member and disposed distally from the reattachable engagement member,
wherein when the reattachable engagement member is secured to the proximal component of the plasma arc torch, the contact member is in electrical contact with the distal component of the plasma arc torch, thereby providing electrical continuity to the torch height control system through the connection member.

13. The plasma arc torch according to claim 12, wherein the continuity device is a single piece.

14. The plasma arc torch according to claim 12, wherein the reattachable engagement member defines a resilient clamping ring adapted for engagement around the proximal component.

15. The plasma arc torch according to claim 14, wherein the resilient clamping ring defines a retaining member that further secures the continuity device to the proximal component.

16. The plasma arc torch according to claim 15, wherein the retaining member defines radially opposed tabs that engage the proximal component.

17. The plasma arc torch according to claim 16, wherein the proximal component defines radially opposed slots, wherein the radially opposed tabs engage the radially opposed slots.

18. The plasma arc torch according to claim 14, wherein the resilient clamping ring further defines at least one resilient finger extending radially outward to facilitate removal of the continuity device.

19. The plasma arc torch according to claim 14, wherein the resilient clamping ring further defines two resilient fingers extending radially outward to facilitate removal of the continuity device.

20. The plasma arc torch according to claim 12, wherein the connection member extends radially from the reattachable engagement member.

21. The plasma arc torch according to claim 12, wherein the contact member defines a resilient arm extending distally from the reattachable engagement member.

22. The plasma arc torch according to claim 21, wherein the resilient arm further defines a bead that extends radially inward to contact the distal component.

23. The plasma arc torch according to claim 11, wherein the proximal component is a torch head.

24. The plasma arc torch according to claim 11, wherein the distal component is a shield cap.

25. The plasma arc torch according to claim 24, wherein the shield cap defines a proximal annular wall that contacts the continuity device.

26. The plasma arc torch according to claim 25, wherein the proximal annular wall defines a knurled surface.

27. A continuity device for use in a torch height control system of a plasma arc torch comprising:
a reattachable clamping ring;
a continuity tab disposed adjacent the reattachable clamping ring; and
a resilient arm extending distally from the reattachable clamping ring and in electrical continuity with the continuity tab,
wherein when the reattachable clamping ring is secured to the plasma arc torch, the resilient arm is in electrical contact with a distal component of the plasma arc torch, thereby providing electrical continuity to the torch height control system through the continuity tab.

28. The continuity device according to claim 27, wherein the continuity device is a single piece.

29. The continuity device according to claim 27, wherein the reattachable clamping ring defines a retaining member that further secures the continuity device to the proximal component.

30. The continuity device according to claim 29, wherein the retaining member defines radially opposed tabs that engage the proximal component.

31. The continuity device according to claim 27, wherein the reattachable clamping ring further defines at least one resilient finger extending radially outward to facilitate removal of the continuity device.

32. The continuity device according to claim 27, wherein the reattachable clamping ring further defines two resilient fingers extending radially outward to facilitate removal of the continuity device.

33. The continuity device according to claim 27, wherein the continuity tab extends radially from the reattachable clamping ring.

34. The continuity device according to claim 27, wherein the resilient arm further defines a bead that extends radially inward to contact the distal component.

35. A continuity device for use in a torch height control system of a plasma arc torch comprising:
a reattachable clamping ring;
radially opposed tabs disposed on the reattachable clamping ring that secure the reattachable clamping ring to the plasma arc torch;
resilient fingers disposed on the reattachable clamping ring that provide for installation and removal of the reattachable clamping ring;
a continuity tab disposed adjacent the reattachable clamping ring;
a resilient arm extending distally from the reattachable clamping ring and in electrical continuity with the continuity tab; and
a bead disposed at a distal end of the resilient arm and extending radially inward,
wherein when the reattachable clamping ring is secured to the plasma arc torch, the bead is in electrical contact with a distal component of the plasma arc torch, thereby providing electrical continuity to the torch height control system through the continuity tab.

36. A method of operating a plasma arc torch height control system, the method comprising the steps of:
(a) lowering a plasma arc torch such that a distal component of the plasma arc torch is in contact with a workpiece; and
(b) sensing electrical continuity through a reattachable continuity device secured to the plasma arc torch and in electrical contact with the distal component.

37. A method of operating a plasma arc torch height control system comprising the step of sensing electrical continuity through a reattachable continuity device secured to the plasma arc torch and in electrical contact with a distal component of the plasma arc torch when the distal component contacts a workpiece.

38. A method of operating a plasma arc torch height control system comprising the step of securing a reattachable continuity device to a plasma arc torch for electrical continuity between a workpiece and the torch height control system.

39. The method according to claim 38 further comprising the step of attaching a component of the torch height control system to the reattachable continuity device.

40. A method of operating a plasma arc torch height control system comprising the step of attaching a component of the torch height control system to a reattachable continuity device.
